(19) United States
(12) Patent Application Publication
(10) Pub. No.: US 2026/0003313 A1
(43) Pub. Date: Jan. 1, 2026

(54) IMAGE FORMING APPARATUS

(71) Applicant: CANON KABUSHIKI KAISHA, Tokyo (JP)

(72) Inventor: MASAYOSHI TAKAHASHI, Shizuoka (JP)

(21) Appl. No.: 19/222,451

(22) Filed: May 29, 2025

(30) Foreign Application Priority Data
Jun. 28, 2024 (JP) 2024-105293

(51) Int. Cl. G03G 15/00

(52) U.S. Cl. CPC G03G 15/80; G03G 15/6529; G03G 2215/00721

(57) ABSTRACT

An image forming apparatus configured to form an image on a sheet includes a casing, a first electronic device, a second electronic device, and an electric wire configured to connect the first electronic device and the second electronic device to each other. The electric wire is wound around the casing to form a loop and partially passes through the loop to be tied to the casing.

### BACKGROUND

### Field of the Technology

The present disclosure relates to an image forming apparatus that forms an image on a sheet.

### Description of the Related Art

JP 2009-009048 A discloses a laser beam printer in which electric wires connecting a printed circuit board and a load apparatus are assembled. The electric wires are bound by a bundling band and fixed to a fixing structure portion provided in a wiring path. In addition, the bundling band is fixed to a pair of claw portions provided in the fixing structure portion to prevent positional displacement of the electric wires.

In addition, JP 2023-071218 A discloses a post-processing apparatus in which a bundle of wires is wound around a bent metal wire guide, and the bundle of wires is wired along the wire guide.

However, in an image forming apparatus described in JP 2009-009048 A, it is necessary to provide the bundling band, and a component cost of the bundling band and a work cost for fastening the bundling band to the electric wires are increased, which results in an increase in cost. In addition, the wire guide of JP 2023-071218 A has a shape in which a plurality of square waves are formed by performing bending processing a plurality of times, is formed to be long along the bundle of wires, and requires a space for providing the wire guide.

### SUMMARY

According to a first aspect of the present disclosure, an image forming apparatus configured to form an image on a sheet includes a casing, a first electronic device, a second electronic device, and an electric wire configured to connect the first electronic device and the second electronic device to each other. The electric wire is wound around the casing to form a loop and partially passes through the loop to be tied to the casing.

Features of the present disclosure will become apparent from the following description of embodiments with reference to the attached drawings. The following description of embodiments are described by way of example.

### BRIEF DESCRIPTION OF THE DRAWINGS

FIG. 1 is an overall schematic diagram illustrating an image forming apparatus according to a first embodiment.

FIG. 2A is a perspective view illustrating an electric wire.

FIG. 2B is a perspective view illustrating an arrangement example of the electric wire arranged in the image forming apparatus.

FIG. 3 is a perspective view illustrating arrangement of an electric wire according to a comparative example.

FIG. 4 is a perspective view illustrating an electric wire and a main board according to a second embodiment.

FIG. 5 is a side view illustrating an electric wire, a hook, and a main board according to a third embodiment.

FIG. 6 is a perspective view illustrating a hook according to a fourth embodiment.

### DESCRIPTION OF THE EMBODIMENTS

### First Embodiment

### Overall Configuration

First, a first embodiment of the present disclosure will be described. An image forming apparatus 200 according to the present embodiment is an electrophotographic laser beam printer. Note that the image forming apparatus includes a printer, a copier, a facsimile, and a multifunction peripheral, and refers to an apparatus that forms an image on a sheet used as a recording medium based on image information input from an external personal computer (PC) or image information read from a document. In addition to including a body having an image forming function, the image forming apparatus may be connected to an accessory device such as an option feeder, an image reading device, or a sheet processing device, and the entire system to which such an accessory device is connected is also a type of the image forming apparatus.

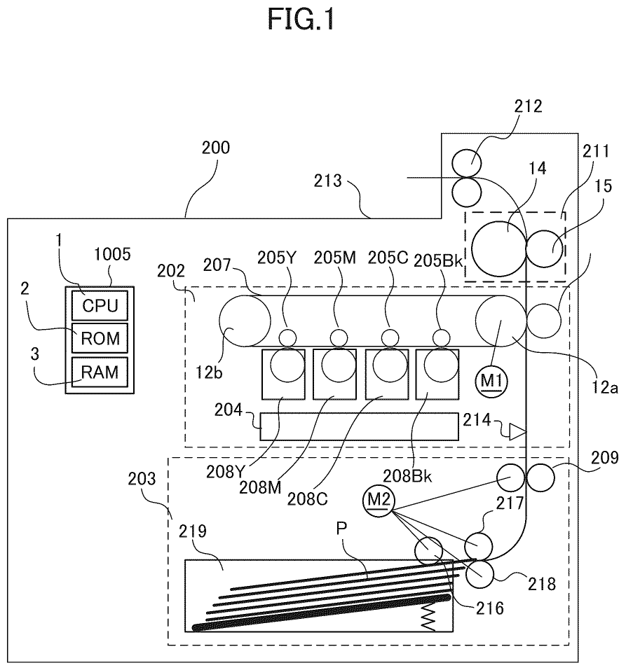

As illustrated in FIG. 1, the image forming apparatus 200 includes an image forming unit 202 that forms an image on a sheet P, a sheet feeding device 203, and a fixing device 211. The image forming unit 202 includes four process cartridges 208Y, 208M, 208C, and 208Bk that form toner images of four colors of yellow (Y), magenta (M), cyan (C), and black (Bk), respectively, and a scanner unit 204. The sheet P includes paper such as a sheet or an envelope, a plastic film such as a sheet for an overhead projector (OHP), cloth, and the like.

The four process cartridges 208Y, 208M, 208C, and 208Bk have the same configuration except that colors of images to be formed are different. Therefore, only the configuration and image forming process of the process cartridge 208Y will be described, and a description of the process cartridges 208M, 208C, and 208Bk will be omitted.

The process cartridge 208Y includes a photosensitive drum 206 serving as an image bearing member, a charger (not illustrated), and a developing device (not illustrated). The photosensitive drum 206 is formed by applying an organic photoconductive layer to an outer periphery of an aluminum cylinder, and is rotated by a drive motor (not illustrated). The image forming unit 202 is provided with an intermediate transfer belt 207 wound around a driving roller 12a and a tension roller 12b, and primary transfer rollers 205Y, 205M, 205C, and 205Bk are provided on an inner side of the intermediate transfer belt 207. A secondary transfer roller 210 is disposed opposite to the driving roller 12a while having the intermediate transfer belt 207 interposed therebetween.

The fixing device 211 includes a fixing roller 14 heated by a heater (not illustrated) and a pressure roller 15 that is in pressure contact with the fixing roller 14. The sheet feeding device 203 is provided at a lower portion of the image forming apparatus 200 and includes a cassette 219 that supports the sheet P, a feeding roller 216 that feeds the sheet P, a conveyance roller 217, a separation roller 218, and a conveyance roller pair 209. The separation roller 218 forms a separation nip that separates the fed sheets P one by one together with the conveyance roller 217.

In addition, the image forming apparatus 200 is provided with a main board 1005 that controls an image forming operation and a feeding operation and conveyance operation for the sheet P in the image forming apparatus 200. The main board 1005 serving as a second electronic device and a control board includes a central processing unit (CPU) 1 and a read only memory (ROM) 2 that stores various programs. In addition, the main board 1005 includes a random access memory (RAM) 3 used as a work area of the CPU 1.

Next, the image forming operation of the image forming apparatus 200 configured as described above will be described. When an image signal is input to the scanner unit 204 from a personal computer (not illustrated) or the like, laser light corresponding to the image signal is emitted from the scanner unit 204 onto the photosensitive drum 206 of the process cartridge 208Y.

At this time, a surface of the photosensitive drum 206 is uniformly charged in advance to a predetermined polarity and potential by the charger, and an electrostatic latent image is formed on the surface of the photosensitive drum 206 by irradiation with the laser light from the scanner unit 204. The electrostatic latent image formed on the photosensitive drum 206 is developed by the developing device, and the toner image of yellow (Y) is formed on the photosensitive drum 206.

Similarly, the respective photosensitive drums of the process cartridges 208M, 208C, and 208Bk are also irradiated with the laser light from the scanner unit 204, and the toner images of magenta (M), cyan (C), and black (Bk) are formed on the respective photosensitive drums. The toner image of each color formed on each photosensitive drum is transferred to the intermediate transfer belt 207 by the primary transfer rollers 205Y, 205M, 205C, and 205Bk. Then, the toner image of each color is conveyed to the secondary transfer roller 210 by the intermediate transfer belt 207 rotated by the driving roller 12a. The image forming process for each color is performed at a timing of superimposing a toner image on an upstream toner image primarily transferred onto the intermediate transfer belt 207. The driving roller 12a is driven by a conveyance motor M1 and rotates at a constant speed.

In parallel with the image forming process, the sheet P stored in the cassette 219 of the sheet feeding device 203 is fed by the feeding roller 216, the conveyance roller 217, and the separation roller 218, and then conveyed to the conveyance roller pair 209. A registration sensor 214 is provided downstream of the conveyance roller pair 209 in a sheet conveyance direction, and the registration sensor 214 detects positions of a leading edge and a trailing edge of the conveyed sheet P. That is, the registration sensor 214 detects the position of the sheet P.

The sheet P is subjected to acceleration/deceleration control such that the image on the intermediate transfer belt 207 and the position of the sheet P are aligned based on detection results of a first electronic device and the registration sensor 214 serving as a sensor. That is, the feeding motor M2 that drives the feeding roller 216, the conveyance roller 217, the separation roller 218, and the conveyance roller pair 209 is subjected to acceleration/deceleration control by the CPU 1.

Then, a full-color toner image on the intermediate transfer belt 207 is transferred to the sheet P by a secondary transfer bias applied to the secondary transfer roller 210. Predetermined heat and pressure are applied to the sheet P to which the toner image has been transferred by the fixing roller 14 and the pressure roller 15 of the fixing device 211, and the toner is melted and fixed. The sheet P having passed through the fixing device 211 is discharged to a sheet discharge tray 213 by a sheet discharge roller pair 212.

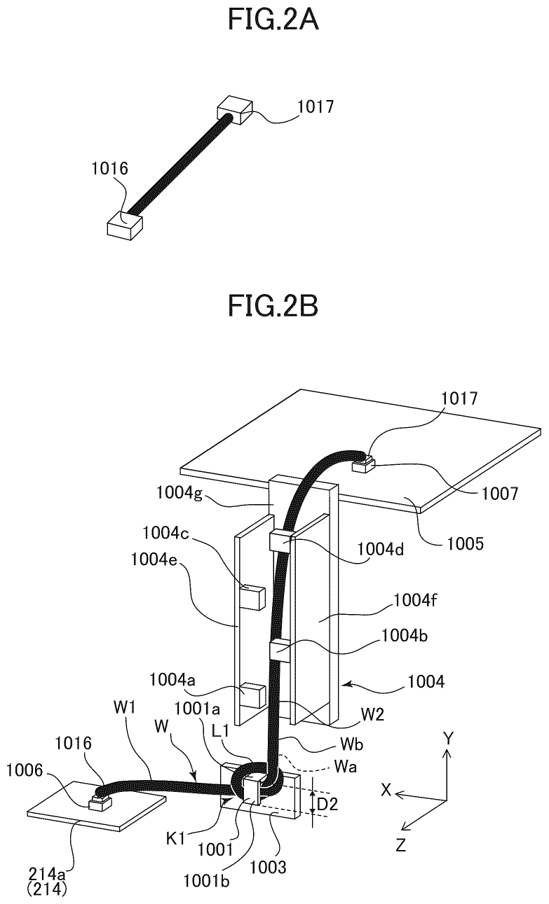

In the present embodiment, the registration sensor 214 includes a registration sensor board 214a (see FIGS. 2A and 2B) and a detection element (not illustrated) mounted on the registration sensor board 214a. Examples of the detection element include a light receiving element, an ultrasonic element, and a pressure-sensitive element. In a case where the light receiving element is applied as the detection element, the registration sensor 214 includes, for example, a pivoting member that pivots by being pressed by the conveyed sheet P, and the sheet P is detected in a manner in which the light receiving element is turned on or off according to the pivoting of the pivoting member. Then, the registration sensor 214 is connected to the main board 1005 by an electric wire W.

### Arrangement of Electric Wire

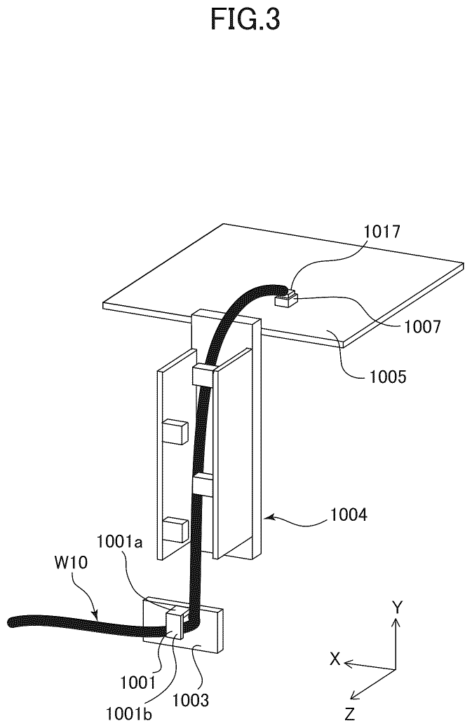

Next, arrangement of the electric wire W will be described with reference to FIGS. 2A to 3. FIG. 2A is a perspective view illustrating the electric wire W. FIG. 2B is a perspective view illustrating an arrangement example of the electric wire W arranged in the image forming apparatus 200. FIG. 3 is a perspective view illustrating arrangement of an electric wire W10 according to a comparative example.

As illustrated in FIG. 2A, electric wire connectors 1016 and 1017 are attached to both ends of the electric wire W. As illustrated in FIG. 2B, the registration sensor board 214a serving as a first board is provided with a board connector 1006 serving as a first connector, and the main board 1005 serving as a second board is also provided with a board connector 1007 serving as a second connector. Then, the electric wire connector 1016 serving as a first end portion is connected to the board connector 1006, and the electric wire connector 1017 serving as a second end portion is connected to the board connector 1007. As a result, the registration sensor board 214a and the main board 1005 are electrically connected to each other via the electric wire W.

The electric wire W includes a conductor Wa and an insulating sheath Wb covering the conductor Wa, and the conductor Wa transmits at least one of a signal and power. In addition, the number of conductors Wa covered with the insulating sheath Wb is not limited to one, and may be plural. In addition, the electric wire W is not limited to having a circular cross section, and includes, for example, a flexible flat cable formed to be flat.

The image forming apparatus 200 includes a casing 1003 including a hook 1001 and an electric wire guide 1004 serving as a guide portion that guides the electric wire W. The hook 1001 and the electric wire guide 1004 are disposed along the wiring path of the electric wire W, and the electric wire W is held by the hook 1001 and is routed in the electric wire guide 1004. In the present embodiment, the casing 1003 is, for example, a part of a frame that supports the process cartridges 208Y to 208Bk.

Hereinafter, one direction parallel to a horizontal direction is defined as an X direction serving as a third direction, and a vertical direction is defined as a Y direction serving as a second direction. A direction orthogonal to the X direction and the Y direction is defined as a Z direction serving as a first direction. The X direction, the Y direction, and the Z direction are orthogonal to each other. That is, the X direction intersects or is orthogonal to both the Y direction and the Z direction. An upper side in the vertical direction is defined as a +Y direction, and a lower side in the vertical direction is defined as a −Y direction. A direction indicated by an arrow indicating the X direction in FIGS. 2A and 2B is defined as a +X direction, and a direction opposite to the +X direction is defined as a −X direction. Similarly, a direction indicated by an arrow indicating the Z direction in FIGS. 2A and 2B is defined as a +Z direction, and a direction opposite to the +Z direction is defined as a −Z direction. The X direction, the Y direction, and the Z direction are not necessarily orthogonal to each other, and it is sufficient if the X direction, the Y direction, and the Z direction intersect each other.

The hook 1001 serving as a protrusion has a first portion 1001a protruding in the Z direction and a second portion 1001b extending in the −Y direction from a distal end portion of the first portion 1001a, and is formed to have a substantially L-shaped cross section. In the present embodiment, the hook 1001 is made of a resin material, but is not limited thereto, and may be made of, for example, a metal material.

The electric wire guide 1004 is disposed above the hook 1001. The electric wire guide 1004 includes side walls 1004e and 1004f facing each other in the X direction, a connection wall 1004g connecting the side walls 1004e and 1004f to each other, and four claw portions 1004a, 1004b, 1004c, and 1004d. The side walls 1004e and 1004f and the connection wall 1004g extend in the Y direction and form a tubular shape whose sides corresponding to the Z direction (+Z direction), the −Y direction, and the +Y direction are opened. The claw portions 1004a and 1004c protrude in the −X direction from a distal end portion of the side wall 1004e, the distal end portion being on a side of the side wall 1004e that is opposite to the connection wall 1004g. The claw portions 1004b and 1004d protrude in the +X direction from a distal end portion of the side wall 1004f, the distal end portion being on a side of the side wall 1004f that is opposite to the connection wall 1004g.

The claw portions 1004a, 1004b, 1004c, and 1004d are arranged in this order in the +Y direction and alternately extend in the X direction. The electric wire W passes through a space formed by the side walls 1004e and 1004f, the connection wall 1004g, and the claw portions 1004a, 1004b, 1004c, and 1004d, and is guided in the Y direction. A gap is formed between adjacent claw portions among the claw portions 1004a, 1004b, 1004c, and 1004d, and the electric wire W can be routed through the claw portions 1004a, 1004b, 1004c, and 1004d.

A first end portion of the electric wire W is connected to the board connector 1006, and the electric wire W is routed in the −X direction, passes through the hook 1001, and then is routed in the +Y direction. Then, the electric wire W is guided in the +Y direction by the electric wire guide 1004, passes through the electric wire guide 1004, and is then routed in the −Z direction, and a second end portion of the electric wire W is connected to the board connector 1007. The board connector 1006 is disposed at a position different from the hook 1001 in the X direction, and the board connector 1007 is disposed at a position different from the hook 1001 in the Y direction. The registration sensor board 214a of the registration sensor 214 and the main board 1005 are disposed at different positions in the Y direction. Further, the electric wire guide 1004 is disposed at a position different from the hook 1001 in the Y direction.

In the above description, a case where the electric wire W is connected to the board connector 1006 has been described as an example, but the present technology is not limited thereto. For example, the electric wire W may be wired such that a second end is first connected to the board connector 1007, the electric wire W passes through the electric wire guide 1004 and the hook 1001, and then a first end of the electric wire W is connected to the board connector 1006. In addition, the electric wire W may be wired so as to be attached to the hook 1001 or the electric wire guide 1004 at first.

Here, wiring of the electric wire W10 according to the comparative example will be described with reference to FIG. 3. As illustrated in FIG. 3, the electric wire W10 is hooked on the hook 1001 and wired toward the electric wire guide 1004. That is, the electric wire W10 is not wound around the hook 1001 in a full turn.

In such a case, the electric wire W10 is likely to sag, and the electric wire W10 is likely to come off the hook 1001. In a case where the second portion 1001b of the hook 1001 extends in the −Y direction such that the electric wire W10 does not come off from the hook 1001, a space is required accordingly. In addition, in a case where a length of the electric wire W10 is shortened to a length substantially equal to that of the wiring path, workability when connecting the electric wire W10 to the board connectors 1006 and 1007 is deteriorated.

Therefore, in the present embodiment, as illustrated in FIG. 2B, the electric wire W is wound around the first portion 1001a of the hook 1001 to form a loop L1. The loop L1 makes a full turn around an outer peripheral surface of the first portion 1001a. The electric wire W partially passes through the loop L1 to be tied to the hook 1001. In other words, the electric wire W is tied to the casing 1003 including the hook 1001 so as not to come off from the casing 1003.

That is, one electric wire W is held by the hook 1001 by being tied in a single knot around the first portion 1001a of the hook 1001. Such a single knot is referred to as a knot K1. One side of the electric wire W extends in the +X direction and the other side of the electric wire W extends in the +Y direction at the knot K1. In other words, the electric wire W has a first wire portion W1 extending in the X direction from the loop L1 and a second wire portion W2 extending in the Y direction from the loop L1. That is, the knot K1 has a function of holding the electric wire W so as not to fall off from the hook 1001 and changing a direction of the wiring path of the electric wire W. In the present embodiment, the board connector 1006 of the registration sensor board 214a is disposed on a +X direction side of the hook 1001, and the electric wire guide 1004 and the board connector 1007 of the main board 1005 are disposed on a +Y direction side of the hook 1001. The main board 1005 extends in the X direction and the Z direction.

The hook 1001 has the second portion 1001b extending in the −Y direction from the first portion 1001a around which the electric wire W is wound. The second portion 1001b restricts movement of the electric wire W to prevent the loop L1 and the knot K1 from falling off from the hook 1001. That is, the second portion 1001b functions as a stopper that restricts the electric wire W from coming off from the hook 1001 in the +Z direction. In the present embodiment, since the electric wire W is tied to the hook 1001, it is possible to suppress the electric wire W from coming off from the hook 1001 while shortening a length of the second portion 1001b in the −Y direction.

Here, the shortest path length of the electric wire W from the board connector 1006 to the board connector 1007 via the hook 1001 is defined as a shortest path length Dmin. At this time, in the present embodiment, a length D1 of the electric wire W from the board connector 1006 to the board connector 1007 via the hook 1001 is set to be longer by an extra length ΔD than the shortest path length Dmin. That is, the length D1 of the electric wire W is expressed by the following Formula (1).

$$D 1 = D min + Δ D \qquad ( 1 )$$

As described above, in the present embodiment, it is possible to improve workability when connecting the electric wire W to the board connectors 1006 and 1007 by making the length D1 of the electric wire W longer than the shortest path length Dmin by the extra length ΔD.

In the present embodiment, a length D2 of the second portion 1001b of the hook 1001 in the Y direction is set to be shorter than the extra length ΔD serving as a predetermined length (D2<ΔD). Normally, in a case where the length D2 of the second portion 1001b is shorter than the extra length ΔD, the electric wire W sags and thus easily come off from the hook 1001. However, in the present embodiment, the electric wire W is held by the hook 1001 by the knot K1. Therefore, it is possible to achieve both improvement in workability when connecting the electric wire W to the board connectors 1006 and 1007 and space saving by shortening the second portion 1001b of the hook 1001.

In the present embodiment, the electric wire W is not fixed to the hook 1001 using a member other than the electric wire W, and the electric wire W itself is tied to the hook 1001. Therefore, it is possible to suppress the electric wire W from coming off from the hook 1001 at low cost. That is, positional displacement of the electric wire W can be suppressed at low cost.

### Second Embodiment

Next, a second embodiment of the present disclosure will be described, and the second embodiment has a configuration in which an orientation of the main board 1005 according to the first embodiment is changed. Therefore, a configuration similar to that of the first embodiment will be described in a manner of omitting illustration or attaching the same reference numerals in the drawings.

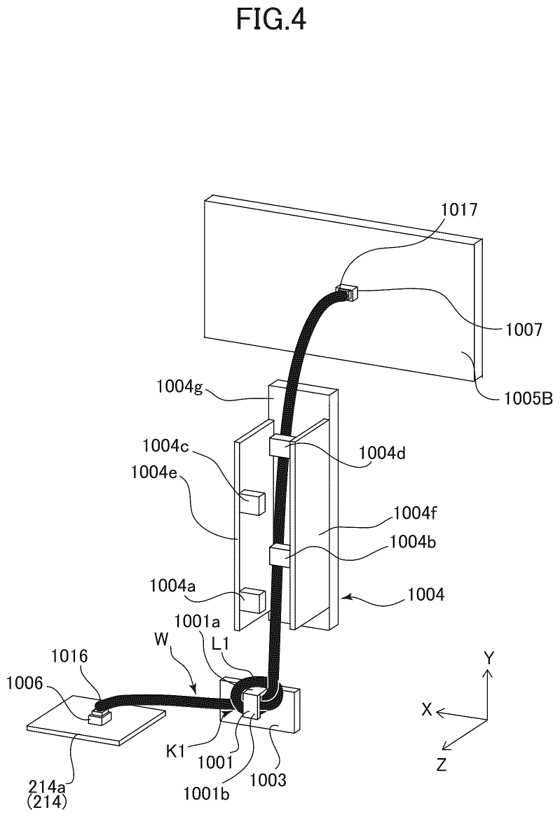

FIG. 4 is a perspective view illustrating an electric wire W and a main board 1005B according to the second embodiment. As illustrated in FIG. 4, the main board 1005B according to the present embodiment extends in the X direction and the Y direction. A board connector 1007 provided on the main board 1005B serving as the second electronic device, the second board, and the control board is oriented in the +Z direction.

As described above, in the present embodiment, the main board 1005B is vertically placed such that the board connector 1007 is oriented in the +Z direction. As a result, it is possible to improve workability when connecting an electric wire connector 1017 of the electric wire W routed through an electric wire guide 1004 to the board connector 1007. The board connector 1007 is provided on a −Z direction side of an electric wire path in the electric wire guide 1004.

In addition, since the main board 1005B is vertically placed, a space in which the main board 1005 is disposed can be saved in the Z direction. Also in the present embodiment, the same effects as those of the first embodiment can be obtained.

### Third Embodiment

Next, a third embodiment of the present disclosure will be described, and the third embodiment has a configuration in which disposition of the hook 1001 and the main board 1005 according to the first embodiment is changed. Therefore, a configuration similar to that of the first embodiment will be described in a manner of omitting illustration or attaching the same reference numerals in the drawings.

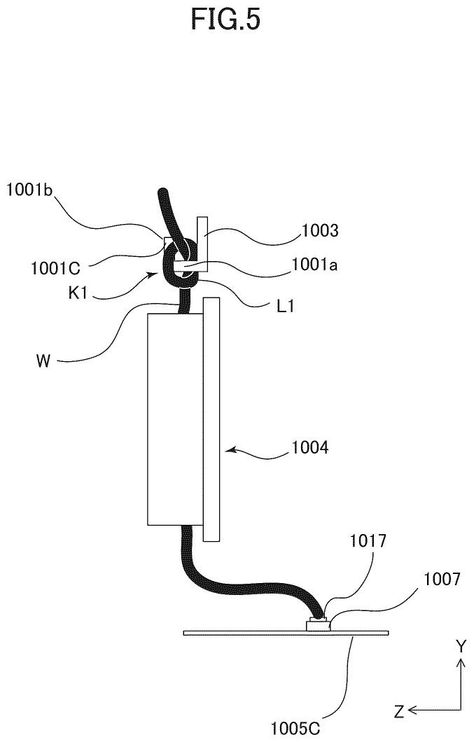

FIG. 5 is a side view illustrating an electric wire W, a hook 1001C, and a main board 1005C according to the third embodiment. As illustrated in FIG. 5, the hook 1001C according to the present embodiment is disposed above (+Y direction side) an electric wire guide 1004, and the main board 1005C is disposed below the electric wire guide 1004 (−Y direction side). Although not illustrated in FIG. 5, a registration sensor board 214a is disposed above the electric wire guide 1004 and the main board 1005C.

The hook 1001C serving as a protrusion has a first portion 1001a and a second portion 1001b, and the second portion 1001b extends in the +Y direction from a distal end of the first portion 1001a. Similarly to the first embodiment, the electric wire W is tied to the first portion 1001a so as not to come off from a casing 1003. The second portion 1001b restricts movement of the electric wire W to prevent a knot K1 of the electric wire W from falling off from the hook 1001C. That is, the second portion 1001b functions as a stopper that restricts the electric wire W from coming off from the hook 1001C in the +Z direction.

In the present embodiment, since the electric wire W is tied to the hook 1001C, it is possible to suppress the electric wire W from coming off from the hook 1001C while shortening a length of the second portion 1001b in the +Y direction. Also in the present embodiment, the same effects as those of the first embodiment can be obtained.

### Fourth Embodiment

Next, a fourth embodiment of the present disclosure will be described, and the fourth embodiment has a configuration in which disposition and an orientation of the hook 1001 according to the second embodiment are changed. Therefore, a configuration similar to that of the second embodiment will be described in a manner of omitting illustration or attaching the same reference numerals in the drawings.

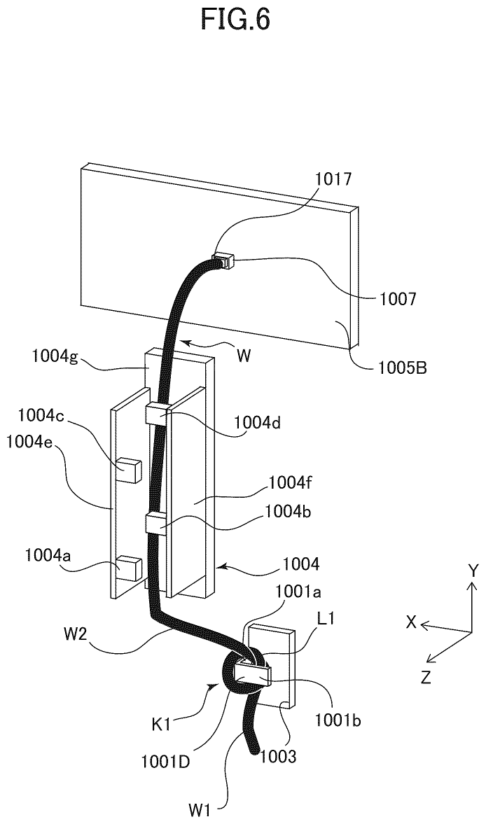

FIG. 6 is a perspective view illustrating a hook 1001D according to the fourth embodiment. Although not illustrated in FIG. 6, a board connector 1006 of a registration sensor board 214a is disposed below an electric wire guide 1004 and a main board 1005B. As illustrated in FIG. 6, the hook 1001D is disposed on a −X direction side of the electric wire guide 1004. A board connector (not illustrated) of the registration sensor board is disposed at a position different from the hook 1001D in the Y direction, and a board connector 1007 is disposed at a position different from the hook 1001D in the X direction.

The hook 1001D serving as a protrusion has a first portion 1001a and a second portion 1001b, and the second portion 1001b extends in the −X direction from a distal end of the first portion 1001a. Similarly to the first embodiment, an electric wire W is tied to the first portion 1001a so as not to come off from a casing 1003. The electric wire W has a first wire portion W1 extending from a loop L1 in the Y direction and a second wire portion W2 extending from the loop L1 in the X direction. In the present embodiment, the X direction, the Y direction, and the Z direction are examples of the second direction, the third direction, and the first direction, respectively. The second portion 1001b restricts movement of the electric wire W to prevent a knot K1 of the electric wire W from falling off from the hook 1001D. That is, the second portion 1001b functions as a stopper that restricts the electric wire W from coming off from the hook 1001D in the +Z direction.

In the present embodiment, since the electric wire W is tied to the hook 1001D, it is possible to suppress the electric wire W from coming off from the hook 1001D while shortening a length of the second portion 1001b in the −X direction. Also in the present embodiment, the same effects as those of the first embodiment can be obtained.

### Other Embodiments

In any of the embodiments described above, the length D1 of the electric wire W is set to be longer than the shortest path length Dmin by the extra length ΔD, and the length D2 of the second portion 1001b of the hook is set to be shorter than the extra length ΔD, but the present technology is not limited thereto. For example, the length D2 of the second portion 1001b may be set to be equal to or longer than the extra length ΔD.

The four claw portions 1004a, 1004b, 1004c, and 1004d are provided in any of the embodiments described above, but the present technology is not limited thereto. For example, one to three or five or more claw portions may be provided, and the number of claw portions is not limited to an even number and may be an odd number.

In any of the embodiments described above, the electric wire W connects the main board 1005 and the registration sensor board 214a of the registration sensor 214 to each other, but the present technology is not limited thereto. For example, the electric wire W may connect the main board 1005 to another sensor or actuator. That is, it is sufficient if the electric wire W transmits at least one of a signal and power between two electronic devices, and the two electronic devices may be arbitrary devices. For example, a high-voltage power supply board may be applied instead of the main board 1005, and the electric wire W may transmit power.

In any of the embodiments described above, the electric wire W forms the single loop L1 with respect to the hook of the casing 1003, but the present technology is not limited thereto. That is, the electric wire W may form two or more loops L1. In addition, the electric wire W may be tied to the hook by passing through one or more of the plurality of loops L1.

In any of the embodiments described above, the hook protrudes from the casing 1003 in the Z direction, but the present technology is not limited thereto. That is, the hook is not limited to protruding in the Z direction, and may protrude, for example, in the X direction or the Y direction, or may protrude in a direction intersecting all of the X direction, the Y direction, and the Z direction. The electric wire W may be tied to a hole provided in the casing 1003 instead of the hook. That is, the casing 1003 may have any shape as long as the electric wire W can be tied.

Although the electrophotographic image forming apparatus 200 has been described in all the embodiments described above, the present technology is not limited thereto. For example, the present disclosure can also be applied to an inkjet type image forming apparatus that forms an image on a sheet by ejecting an ink liquid from a nozzle.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-105293, filed Jun. 28, 2024, which is hereby incorporated by reference herein in its entirety.

What is claimed is:

1. An image forming apparatus configured to form an image on a sheet, the image forming apparatus comprising:
a casing;
a first electronic device;
a second electronic device; and
an electric wire configured to connect the first electronic device and the second electronic device to each other,
wherein the electric wire is wound around the casing to form a loop and partially passes through the loop to be tied to the casing.

2. The image forming apparatus according to claim 1, wherein the casing includes a protrusion, and
the electric wire is tied to the protrusion.

3. The image forming apparatus according to claim 2, wherein the protrusion includes:
a first portion protruding in a first direction and around which the electric wire is wound; and
a second portion extending in a second direction intersecting the first direction and configured to restrict a movement of the loop of the electric wire.

4. The image forming apparatus according to claim 3, wherein the electric wire includes:
a first wire portion extending from the loop in a third direction intersecting both the first direction and the second direction; and
a second wire portion extending from the loop in the second direction.

5. The image forming apparatus according to claim 4, wherein the first electronic device includes:
a first board; and
a first connector provided on the first board and to which a first end portion of the electric wire is connected,
the second electronic device includes:
a second board; and
a second connector provided on the second board and to which a second end portion of the electric wire is connected,
the first connector is disposed at a position different from the protrusion in the third direction, and
the second connector is disposed at a position different from the protrusion in the second direction.

6. The image forming apparatus according to claim 5, wherein the electric wire is longer by a predetermined length than a shortest path length of the electric wire from the first connector to the second connector via the protrusion.

7. The image forming apparatus according to claim 6, wherein a length of the second portion of the protrusion in the second direction is shorter than the predetermined length.

8. The image forming apparatus according to claim 4, further comprising a guide portion configured to guide the electric wire in a vertical direction,
wherein the first electronic device is disposed at a position different from the second electronic device in the vertical direction.

9. The image forming apparatus according to claim 8, wherein the second direction is the vertical direction.

10. The image forming apparatus according to claim 8, wherein the third direction is the vertical direction.

11. The image forming apparatus according to claim 8, wherein the guide portion is disposed at a position different from the protrusion in the vertical direction.

12. The image forming apparatus according to claim 1, wherein the electric wire includes a conductor and an insulating sheath covering the conductor.

13. The image forming apparatus according to claim 12, wherein the conductor transmits at least one of a signal and power between the first electronic device and the second electronic device.

14. The image forming apparatus according to claim 1, wherein the first electronic device is a sensor configured to detect a position of the sheet, and
the second electronic device is a control board.
